(19) United States
(12) Patent Application Publication
(10) Pub. No.: US 2017/0079002 A1
(43) Pub. Date: Mar. 16, 2017

(54) Communication System, Wired Communication Device, Control Method, and Control Program

(71) Applicant: Yamaha Corporation, Hamamatsu-shi, Shizuoka (JP)

(72) Inventors: Shogo FUJITA, Hamamatsu-shi, Shizuoka (JP); Nobuhiko UEMURA, Hamamatsu-shi, Shizuoka (JP); Tatsuya SEO, Hamamatsu-shi, Shizuoka (JP)

(21) Appl. No.: 15/120,173

(22) PCT Filed: Feb. 19, 2015
(86) PCT No.: PCT/JP2015/054692

§ 371 Date: Aug. 19, 2016

(30) Foreign Application Priority Data
Feb. 20, 2014 (JP) 2014-030231

(51) Int. Cl. H04W 64/00; H04W 40/24; H04B 7/14

(52) U.S. Cl. CPC H04W 64/00; H04B 7/14; H04W 40/244; H04W 88/08

(57) ABSTRACT

A communication system includes a radio relay device and a wired communication device. The wired communication device includes a wired communication unit which performs wired communication with the radio relay device, a first identification information acquisition unit which acquires identification information of the radio relay device via the wired communication unit, a position information acquisition unit which acquires position information of the radio relay device based on the identification information acquired by the first identification information acquisition unit, and a position information output unit which outputs own position information based on the position information acquired by the position information acquisition unit.

### TECHNICAL FIELD

The present invention relates to a communication system including a position information acquisition device, a radio communication device and a wired communication device performing wired communication with the radio communication device, and also to the wired communication device, a control method and a control program.

### BACKGROUND ART

A position of a terminal can be specified using, for example, a GPS (Global Positioning System). However, in order to specify a position of the terminal using the GPS, it is required to receive radio wave from a GPS satellite. Thus, if the terminal is located in the interior of a house or an underground room, it is difficult to specify a position of the terminal.

For example, a method of employing a radio access point has been known as a technique of specifying the position in the interior of a house or an underground room (see Patent Literature 1, Patent Literature 2 and Patent Literature 3).

In the method of employing the radio access point, firstly position information and identification information (for example, an MAC address (Media Access Control address) of each of the radio access points is registered in a database in advance. The terminal performs communication with the radio access point using a radio communication function, and acquires identification information and information of a radio field intensity of this radio access point. The terminal acquires position information from the database using the received identification information. As the radio field intensity is inversely proportional to the square of a distance, the radio field intensity can be converted into information relating to a distance between this radio access point and the terminal. As a result, the terminal can estimate the position of the own terminal using the acquired position information and the information relating to the distance.

Particularly, if the terminal is capable of performing communication with a plurality of (at least three) radio access points, the terminal can estimate the position of the own terminal more accurately by transmitting/receiving the identification information and the information of radio field intensities of these plurality of radio access points.

### CITATION LIST

### Patent Literature

Patent Literature 1: JP-A-2008-131301

Patent Literature 2: JP-A-2008-199422

Patent Literature 3: JP-A-2009-65604

### SUMMARY OF INVENTION

### Technical Problem

However, a device not implementing a GPS or a radio communication function cannot estimate a position of the own device.

Accordingly, an object of the present invention is to provide, in a device not implementing a position specifying function or a radio communication function, a technique which can estimate a position of the own device.

### Solution to Problem

A communication system according to the present invention includes a radio relay device and a wired communication device. The relay device is, for example, a radio access point, a radio router or the like. The wired communication device is, for example, a router, a server, a PC (Personal Computer) or the like.

The wired communication device includes a first identification information acquisition unit which acquires identification information of the radio relay device via a wired communication function, and a position information acquisition unit which acquires position information of the radio relay device based on the identification information acquired by the first identification information acquisition unit, for example, from a position information table in which the identification information is associated with the position information.

The identification information is, for example, an MAC address. The position information table is stored, for example, in a database in which the identification information and the position information of the radio relay devices are registered in an association manner. The position information acquisition unit can acquire a position of the radio relay device by reading the database based on the acquired identification information.

The wired communication device includes a position information output unit which outputs own position information based on the position information acquired by the position information acquisition unit. In this manner, even if the wired communication device does not implement a position specifying function or a radio communication function, this device can estimate an own position and output as the position information of the own device.

Incidentally, the communication system according to the present invention is also applicable to an aspect further including a radio communication terminal. The radio communication terminal is constituted of an information processing device such as a smartphone.

The radio communication terminal includes a second identification information acquisition unit which acquires identification information of the radio relay device via the radio communication function. Further, the radio communication terminal includes a position estimation unit which estimates a position of the radio relay device.

For example, in a case where the database in which the identification information and the position information of the radio relay devices are registered in the association manner exists already, the position estimation unit can estimate the position of the radio relay device by reading the database based on the acquired identification information. In a case where the radio communication terminal has a function (for example, a GPS) of specifying a position of the own terminal, the position estimation unit can also estimate the position of the radio relay device based on the position of the own terminal specified by the position specifying function and a received radio field intensity of a beacon signal outputted from the radio relay device. As the radio field intensity is inversely proportional to the square of a distance, the radio field intensity can be converted into information relating to a distance between the radio relay device and the radio communication terminal. In particular, the radio communication terminal can accurately estimate the position of the radio relay device based on triangulation by performing radio communication with the radio relay device at three positions at least.

Then the radio communication terminal outputs the position information table in which the estimated positions of the radio relay devices are associated with the acquired identification information of these radio relay devices, respectively.

Incidentally, the radio communication terminal may transmit the position of the own terminal and the received radio field intensity of the beacon signal to the radio relay device, and the radio relay device may estimate the position of the own device based on the position of the radio communication terminal and the received radio field intensity of the beacon signal received from the radio communication terminal. In this case, the radio communication terminal outputs the position information table in which the estimated position of the own device is associated with identification information of the own terminal.

The position information of the own terminal estimated by the radio communication device in the aforesaid manner is transmitted to, for example, a center device (center router) connected to a plurality of wired communication devices. The center device includes a position information request unit which transmits a position information request to each of the wired communication devices, and a position information reception unit which receives the respective position information corresponding to the position information requests. The center device displays the wired communication devices on, for example, a map based on the received respective position information. By doing so, a network manager can visually grasp the position of each of the wired communication devices distributed in a wide area.

Incidentally, it is also possible to employ an aspect in which the position acquisition unit acquires the position information of the radio relay device by causing the radio relay device to refer to the position information table.

Further, a wired communication device according to the present invention includes: a wired communication unit which performs wired communication with a radio relay device; a first identification information acquisition unit which acquires identification information of the radio relay device via the wired communication unit; a position information acquisition unit which acquires position information of the radio relay device based on the identification information acquired by the first identification information acquisition unit; and a position information output unit which outputs own position information based on the position information acquired by the position information acquisition unit.

Further, a control method according to the present invention is a control method in a wired communication device which performs wired communication with a radio relay device, in which the method includes: acquiring identification information of the radio relay device via a wired communication unit; acquiring position information of the radio relay device based on the acquired identification information; and outputting position information of the wired communication device based on the acquired position information.

Further, a control program according to the present invention makes a wired communication device execute: a wired communication function which performs wired communication with a radio relay device; a first identification information acquisition function which acquires identification information of the radio relay device via the wired communication function; a position information acquisition function which acquires position information of the radio relay device based on the identification information acquired by the first identification information acquisition function; and a position information output function which outputs own position information based on the position information acquired by the position information acquisition function.

### Advantageous Effects of Invention

According to the present invention, even in a device not implementing a position specifying function or a radio communication function, a position of the own device can be estimated.

### BRIEF DESCRIPTION OF DRAWINGS

FIG. 1 is a schematic diagram illustrating configuration of a communication system.

FIG. 2 includes block diagrams illustrating configuration of routers.

FIG. 3 is a block diagram illustrating configuration of a radio access point.

FIG. 4 is a block diagram illustrating configuration of a radio communication terminal.

FIG. 5 is a flowchart illustrating operations of the radio communication terminal, the radio access point, a base router, a database and a center router.

FIG. 6 is a flowchart illustrating operations of the radio communication terminal, the radio access point, the base router, the database and the center router, according to a modified example.

FIG. 7 is a diagram illustrating an example of a network map.

FIG. 8 is a flowchart illustrating operations of the radio access point, the database and the base router

### DESCRIPTION OF EMBODIMENTS

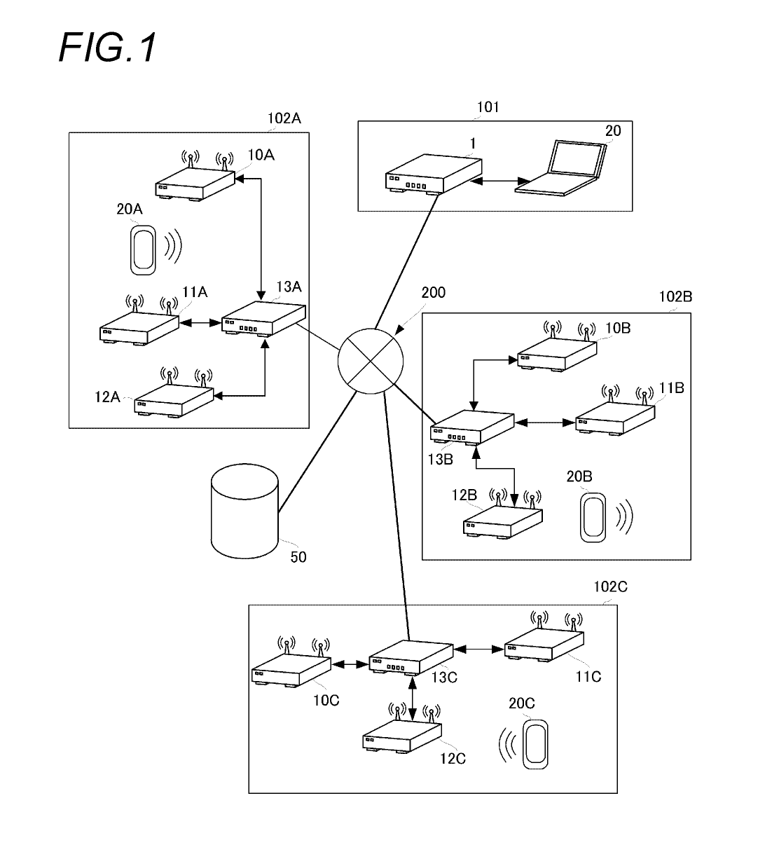

FIG. 1 is a schematic diagram illustrating configuration of a communication system according to an embodiment. The communication system includes a router 1, a router 13A, a router 13B, a router 13C and a database 50 which are mutually connected via the internet 200.

The router 1 is a center router (corresponds to a center device according to the present invention) installed at a center base 101 serving as a core such as a head office. The router 13A, the router 13B and the router 13C are edge routers (base routers) installed at a base 102A, a base 102B and a base 102C serving as business facilities or the like at various places, respectively. Each of the router 13A, the router 13B and the router 13C corresponds to a wired communication device according to the present invention.

The router 1 is connected to a terminal 20 which is operated by a network manager so as to issue an instruction. The terminal 20 is constituted of an information processing device such as a personal computer (PC). The router 13A is connected to a radio access point (hereinafter referred to as an AP) 10A, an AP 11A and an AP 12A. The router 13B is connected to an AP 10B, an AP 11B and an AP 12B. The router 13C is connected to an AP 10C, an AP 11C and an AP 12C. In this embodiment, although the AP is shown as an example of a radio relay device according to the present invention, a radio router or the like containing a router function also corresponds to the radio relay device according to the present invention. Further, in this embodiment, although the router is shown as an example of the wired communication device according to the present invention, a device (a device not implementing a position specifying function or a radio communication function) such as a server or a PC also corresponds to the wired communication device according to the present invention.

Further, a radio communication terminal 20A is arranged in the base 102A, a radio communication terminal 20B is arranged in the base 102B and a radio communication terminal 20C is arranged in the base 102C. Each of the radio communication terminal 20A, the radio communication terminal 20B and the radio communication terminal 20C is constituted of an information processing device such as a smartphone.

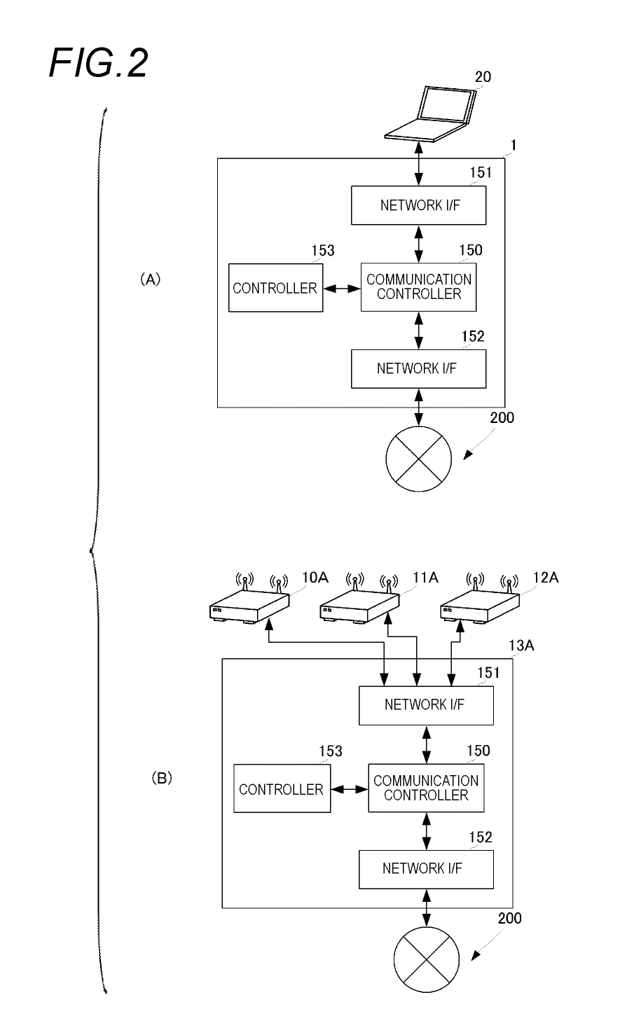

FIG. 2(A) is a block diagram illustrating configuration of the router 1, and FIG. 2(B) is a block diagram illustrating configuration of the router 13A. The router 1 functions as the center router and is connected to the terminal 20. Each of the other routers 13A, 13B and 13C is connected to the APs and functions as the base router. Each of the routers 1, 13A, 13B and 13C has the same hardware configuration. FIG. 2(B) shows the configuration of the router 13A as a representative of these routers.

Each of the routers 1, 13A, 13B and 13C includes a communication controller 150, a network I/F 151, a network I/F 152 and a controller 153. The communication controller 150 is connected to the network I/F 151, the network I/F 152 and the controller 153.

The controller 153 reads a firmware program stored in a built-in medium (not shown) such as an ROM and unitedly controls the own device. The controller 153 realizes “a first identification information acquisition unit”, “a position information acquisition unit” and “a position information output unit” according to the present invention by the firmware program. The controller 153 of the router 1 realizes “a position information request unit” and “a position information reception unit” according to the present invention.

The network I/F 151 is an interface on an LAN side and corresponds to “a wired communication unit” according to the present invention. In this example, the network I/F 151 contains a hub function and is connected to plural devices. As shown in FIG. 1(A), in the router 1, the network I/F 151 is connected to the terminal 20. As shown in FIG. 2(B), in the router 13A, the network I/F 151 is connected to the AP 10A, the AP 11A and the AP 12A.

The network I/F 152 is an interface on a WAN side and connected to the internet 200. The communication controller 150 analyzes date (packets) received by each of the network I/F 151 and the network I/F 152 and transfers the data. For example, when a user instructs transmission of predetermined data to the router 13A using the terminal 20, the terminal 20 transmits the date to the network I/F 151 of the router 1. The communication controller 150 analyzes the data received by the network I/F 151 and refers to an address (IP address or the like) contained in the data. The communication controller 150 transfers the data to the router 13A via the network I/F 152 and the internet 200 based on this address. The router 13A receives this data by the network I/F 152. The communication controller 150 of the router 13A analyzes the data thus received and transfers the data. Incidentally, in a case where the received data is data addressed to the own device, the communication controller 150 outputs the received data to the controller 153. The controller 153 performs a processing according to this data.

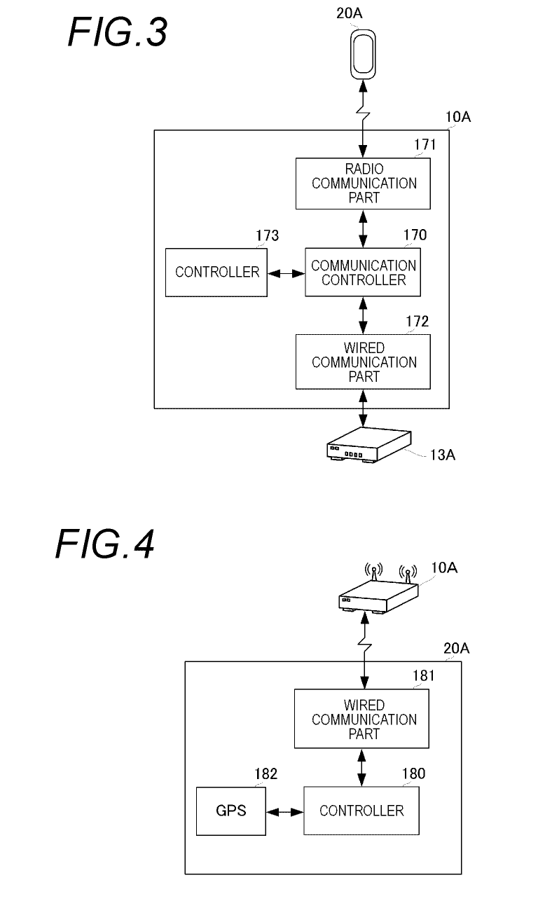

Next, FIG. 3 is a block diagram illustrating configuration of the AP 10A. In this embodiment, each of the other APs has the same hardware configuration. Thus, FIG. 3 shows the configuration of the AP 10A as a representative of these APs and the configuration of the other APs is omitted.

The AP 10A includes a communication controller 170, a radio communication part 171, a wired communication part 172 and a controller 173. The communication controller 170 is connected to the radio communication part 171, the wired communication part 172 and the controller 173.

The radio communication part 171 is connected to the radio communication terminal 20A, and performs data transmission and reception with the radio communication terminal 20A via radio wave. The wired communication part 172 performs data transmission and reception with the router 13A via a wired connection such as an LAN cable. The communication controller 170 analyzes the data received via the radio communication part 171 or the wired communication part 172 and refers to an address contained in the data. The communication controller 170 transfers the data received via the radio communication part 171 or the wired communication part 172, based on the address thus referred.

By doing so, the communication controller 170 can transfer the date received via the wired communication part 172 to the radio communication part 171, and can transfer the date received via the radio communication part 171 to the wired communication part 172. Incidentally, in a case where the received data is data addressed to the own device, the communication controller 170 outputs the received data to the controller 173. The controller 173 performs a processing according to this data.

The controller 173 reads a firmware program stored in a built-in medium (not shown) such as an ROM and wholly controls the AP 10A. For example, the controller 173 periodically (for example, every 100 ms) outputs beacon via the communication controller 170 and the radio communication part 171. The beacon contains identification information (for example, an MAC address or an SSID) of the own device. In this manner, the controller 173 realizes a beacon signal output unit according to the present invention.

Next, FIG. 4 is a block diagram illustrating configuration of the radio communication terminal 20A. The radio communication terminal 20A is constituted of an information processing device such as a smartphone and contains multi-functions. However, FIG. 4 shows only the configuration relating to the present invention and the other configuration is omitted. Each of the radio communication terminal 20A, the radio communication terminal 20B and the radio communication terminal 20C has the same hardware configuration. Thus, FIG. 4 shows the configuration of the radio communication terminal 20A as a representative of these terminals and the configuration of the other radio communication terminals is omitted.

The radio communication terminal 20A includes a controller 180, a radio communication part 181 and a GPS 182. The controller 180 is connected to the radio communication part 181 and the GPS 182.

The radio communication part 181 performs radio communication with each of the respective APs and receives various kinds of data. For example, the radio communication part 181 receives the beacon from each of the AP 10A, the AP 11A and the AP 12A. The received beacon is outputted to the controller 180 via the radio communication part 181.

The GPS 182 corresponds to a position specifying unit according to the present invention and specifies a position (for example, a latitude and a longitude) of the own device based on various kinds of signals received from the GPS satellite. The position information of the own device thus specified is outputted to the controller 180.

The controller 180 reads a firmware program stored in a built-in medium (not shown) such as an ROM and unitedly controls the radio communication terminal 20A. The controller 180 receives the beacon from each of the AP 10A, the AP 11A and the AP 12A via the radio communication part 181 and acquires the identification information of the respective APs contained in the beacons. In this manner, the controller 180 realizes “a second identification information acquisition unit” according to the present invention. Further, the controller 180 measures a received radio field intensity of each of the received beacon signals. Furthermore, the controller 180 estimates the position of each of the APs using the position information of the own device acquired via the GPS 182 and the received radio field intensity of the corresponding beacon signal.

As the radio field intensity is inversely proportional to the square of a distance, the radio field intensity can be converted into information relating to a distance between the AP and the own device. For example, in a case where a distance between the AP and the own device is quite short (for example, 30 cm or less), the controller 180 regards that the position of the own device is the same as the position of the AP and estimates the position of the own device as the position of the AP. Further, in a case where the controller 180 acquires the position information of the own device at three positions at least, the controller can accurately estimate the position of the radio access point based on distance information between the AP and each of the respective positions, using triangulation.

Incidentally, for example, also a user of the radio communication terminal 20A can manually input the position of the AP using a user I/F (not shown). In a case of the manual input, information such as a name and the floor number of a building can also be added to the position information.

In this manner, the controller 180 realizes “a position estimation unit” according to the present invention. Then, the controller 180 outputs a position information table in which the estimated position information of the APs is associated with the acquired identification information of these APs, respectively (realizes a position information table output unit according to the present invention). Incidentally, the radio communication terminal side may transmit the position of the own device specified by the GPS 182 and the received radio field intensity of the beacon signal to the AP, and the AP side may estimate the position of the own device based on the position of the radio communication terminal received from the radio communication terminal and the received radio field intensity of the beacon signal. In this case, the AP outputs the position information table in which the estimated position of the own device is associated with the identification information of the own device.

The position information table thus outputted is transmitted to the database 50. The communication between the radio communication terminal 20A and the database 50 may be performed via the each AP (for example, AP 10A), the router 13A and the internet 200. However, if the radio communication terminal 20A has a mobile communication function, this communication may be performed via the mobile communication function and the internet 200.

The database 50 registers the received position information table. By doing so, the database 50 stores the position information of the respective APs. Incidentally, the radio communication terminal 20A may not perform the position measurement of the APs but a server equipped with the database 50 may perform the position measurement of the APs. In this case, the radio communication terminal 20A transmits the position information of the AP, the received radio field intensity of the beacon signal and the position information of the radio communication terminal at the time of receiving the beacon signal to the server equipped with the database 50. The server equipped with the database 50 associates the estimated position information of the APs with the identification information of these APs, respectively, and registers as the position information table.

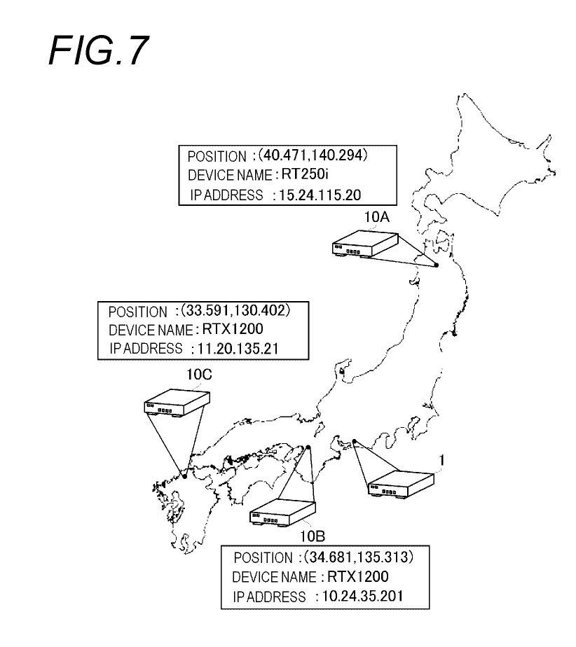

Then, one (for example, the router 13A) of the base routers installed at the respective bases acquires the identification information of the AP (for example, AP 10A) connected to the own device. The router 13A refers to the position information table of the database 50 using the acquired identification information and acquires the position information of the AP 10A. The router 13A regards the position information thus acquired as own position information and outputs. By doing so, the router 13A, not implementing the position specifying function such as the GPS or the radio communication function, can estimate the own position and output it as the position information of the own device. The position information of the respective APs thus outputted is put together in, for example, the router 1 as the center router and utilized for a network map (for example, see FIG. 7). Further, each of the routers may associate the position information of the own device with a global IP address of the own device and store in the center router (or a predetermined database or the like). In a case where the global IP address of the own device is changed, the router updates the stored global IP address. By doing so, another device for performing communication with each of the routers can easily search the position of this router based on the global IP address of this router. In this case, even if the global IP address of the router is changed frequently, the position of the router can be estimated with a high accuracy.

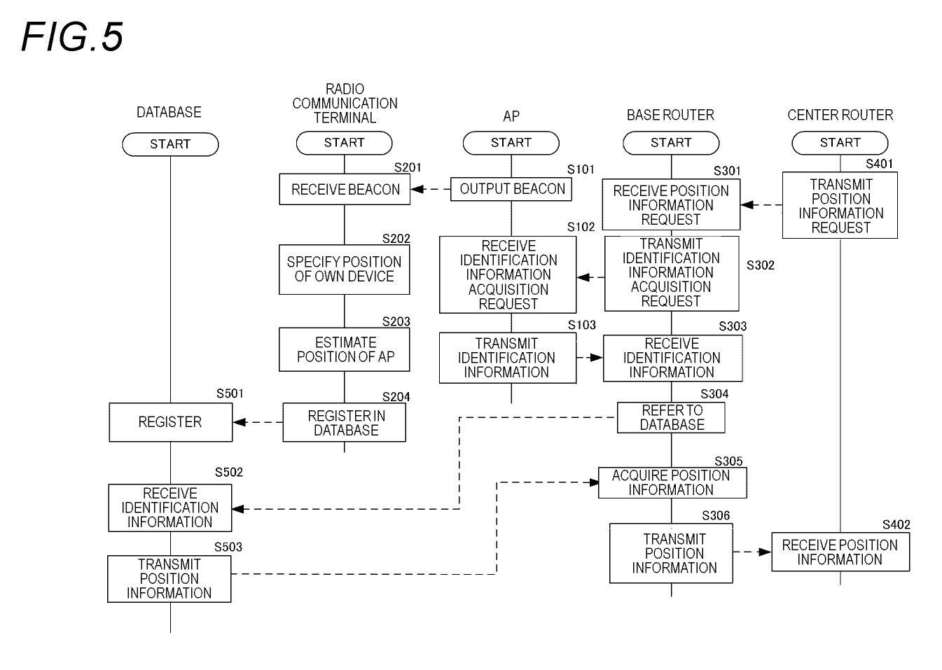

Next, FIG. 5 is a flowchart illustrating operations of the respective devices. Although the “radio communication terminal” in this figure is explained as the radio communication terminal 20A, each of the other radio communication terminals operates in the same manner. Although the “AP” in this figure is explained as the AP 10A, each of the other APs operates in the same manner. Although the “base router” in this figure is explained as the router 13A, each of the other routers 13B and 13C operates in the same manner. The “center router” is explained as the router 1.

The AP 10A periodically outputs the beacon (S101). The radio communication terminal 20A receives the beacon (S201). The radio communication terminal 20A specifies the position of the own device upon receiving the beacon (S202). The position of the own device is specified by the GPS 182.

Next, the radio communication terminal 20A measures the received radio field intensity of the beacon and estimates the position of the AP (S203). In this case, as the beacon from the AP 10A is received, the position of the AP 10A is estimated. The respective positions of the other APs are estimated in the same manner. As described above, the position of the AP is estimated based on the received radio field intensity of the beacon thus measured and the position information of the own device specified by the GPS 182. Alternatively, as described above, a user of the radio communication terminal 20A can manually input the position of the AP using the user I/F (not shown).

Thereafter, the radio communication terminal 20A performs a processing of outputting the position information table in which the estimated position information of the APs is associated with the identification information (for example, MAC addresses) of these APs contained in the beacons, respectively and registering in the database 50 (S204, S501). As described above, the radio communication terminal 20A may not perform the position estimation of the APs but the server equipped with the database 50 may perform the position estimation of the APs. In this case, the radio communication terminal 20A transmits the position information of the AP, the received radio field intensity of the beacon signal and the position information of the radio communication terminal at the time of receiving the beacon signal to the server equipped with the database 50. The server equipped with the database 50 estimates the positions of the respective APs, then prepares the position information table and registers the table in the database. Alternatively, the database may be provided in an external server connected via the internet 200 or in a device (for example, the radio terminal device or the AP) installed in each of the bases. In a case where the database is provided in the device installed in each of the bases, this database can also be used as a database dedicated for a particular user (a manager or the like) or a database referred to by other users.

The router 1 transmits a request for the position information (position information request) to the base router (the router 13A in this case) installed at each of the bases (S401). The position information request is transmitted when a user (network manager) of the terminal 20 connected to the router 1 operates the terminal 20 and instructs the router 1.

When the router 13A receives the position information request (S301), this router transmits an acquisition request for the identification information to each of the APs (AP 10A, AP 11A and AP 12A in this case) connected to the own device (S302).

When the AP 10A receives the identification information acquisition request (S102), this AP transmits the identification information of the own device to the router 13A (S103). The router 13A receives the identification information transmitted from the respective APs (S303). In this manner, “a first identification information acquisition unit” according to the present invention is realized.

Then, the router 13A refers to the position information table of the database 50 based on the acquired identification information of the APs (S304). When the database 50 receives the respective identification information (S502), the database transmits the position information associated with the received respective identification information of the APs (S503). The router 13A acquires the position information associated with each of the APs (S305). In this manner, “a position information acquisition unit” according to the present invention is realized.

The router 13A regards the position information of the respective APs thus acquired as the position information of the own device and transmits to the router 1 (S306).

Incidentally, when the router 13A acquires the position information of the single AP, this router transmits the acquired position information of the AP as it is. In contrast, when the position information of the plural APs is acquired, the router selects the position information of the single AP from the position information of the plural APs and transmits the selected position information as the position information of the own device. For example, the position information of the AP lastly acquired is transmitted as the position information of the own device. Alternatively, latitudes and longitudes contained in the position information of the plural APs may be averaged, and an averaged latitude and an averaged longitude may be transmitted as the position information of the own device. That is, the router 13A determines and transmits the position information of the own device based on the position information of the APs. In this manner, “a position information output unit” according to the present invention is realized.

The router 1 receives the position information transmitted from the respective base routers (S402). The position information thus received is used for the network map, for example. Alternatively, each of the base routers may transmit only the identification information of the APs connected to the own device, and the router 1 may estimate the position of each of the base routers by referring to the position information table of the database 50.

FIG. 7 is a diagram illustrating an example of the network map. In this example, the router 1 displays the respective base routers on a map based on the received position information of the respective base routers. Further, the router 1 displays device information (information such as device names and IP addresses) of each of the base routers. The device information is collected by the router 1 together with the position information. This map is displayed on a display unit of the terminal 20 connected to the router 1. Thus, the network manager can visually grasp the position of each of the base routers distributed in a wide area.

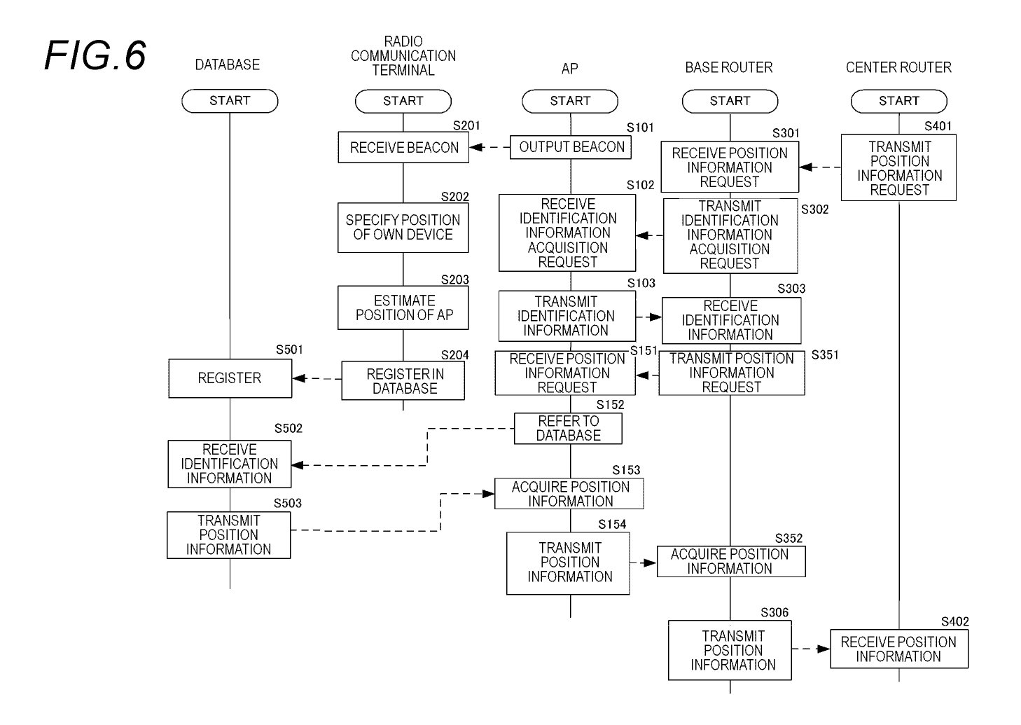

Next, FIG. 6 is a flowchart illustrating operations of the respective devices according to a modified example. In the figure, operations identical to those of FIG. 5 are referred to by the common symbols, with explanation thereof being omitted. Also in FIG. 6, although the “radio communication terminal” in this figure is explained as the radio communication terminal 20A, each of the other radio communication terminals operates in the same manner. Although the “AP” in this figure is explained as the AP 10A, each of the other APs operates in the same manner. Although the “base router” in this figure is explained as the router 13A, each of the other routers 13B and 13C operates in the same manner. The “center router” is explained as the router 1.

Although the example of FIG. 5 shows the mode in which the base router accesses the database 50 and acquires the position information of the AP, the modified example of FIG. 6 shows a mode in which the AP accesses the database 50 and refers to the position information table, thereby acquiring the position information.

When the router 13A acquires the identification information from each of the APs, this router transmits an acquisition request for the position information to each of the APs (S351). When the AP 10A receives the acquisition request for the position information from the router 13A (S151), this AP refers to the position information table of the database 50 using the identification information of the own device (S152) and acquires the associated position information of the own device (S153). The communication between the AP 10A and the database 50 is performed via the router 13A, for example. Then, the AP 10A transmits the position information of the own device thus acquired to the router 13A (S 154).

The router 13A receives the position information from the respective APs (S352), then regards the position information of the respective APs thus acquired as the position information of the own device and transmits to the router 1 (S306). In this manner, “the position information output unit” according to the present invention can also be realized.

Incidentally, the database 50 is not an indispensable configuration in the present invention. For example, a mode, in which the position information table is directly transmitted to each of the base routers from the radio communication terminal, may be employed.

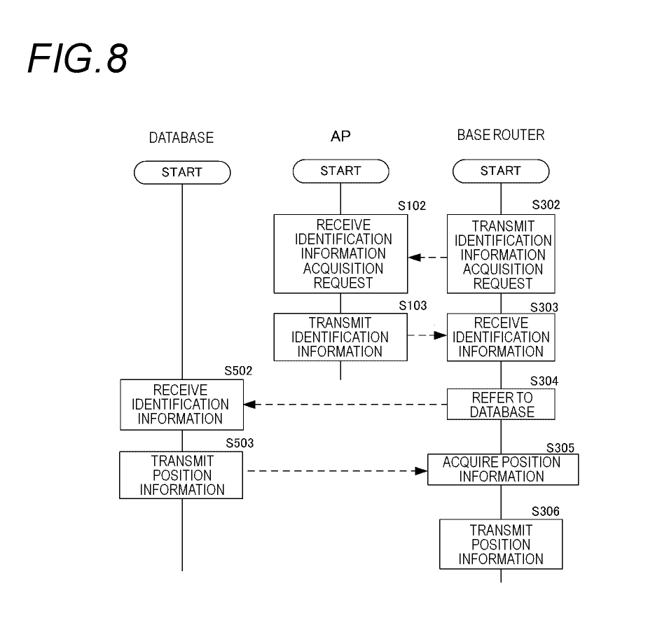

Further, the radio communication terminal (and the center router) are also not indispensable configurations in the present invention, and the AP is not necessarily required to output the beacon signal. For example, as shown in FIG. 8 (in FIG. 8, processings identical to those of FIG. 5 are referred to by the common symbols, with explanation thereof being omitted), a mode may be employed in which the base router acquires the identification information of the AP (S301, S102, S103 and S303), then acquires the position information of the AP by referring to the database (S304, S502, S503 and S305) and outputs the squired position information as the position information of the own device (S306).

In the aforesaid example, although the base router refers to the position information table at the time of acquiring the position information of the AP based on the identification information of the AP, the position information table is not necessarily required. Hereinafter, an example where the identification information of the AP is acquired without using the position information table will be explained.

### MODIFIED EXAMPLE 1

An application program for transmitting the position information and the radio field intensity to the AP from the radio communication terminal is installed in the radio communication terminal in advance. In a state where the application program is started, the radio communication terminal transmits the position information of the own device and the information of the received radio field intensity to the AP.

The AP receives the position information and the information of the radio field intensity from the radio communication terminal and estimates the position of this AP based on the position information and the radio field intensity thus received. As such the estimation method of the position of the AP, the aforesaid method, that is, a method same as that explained as to the function of the “position estimation unit” of the controller 180 can be employed. Incidentally, in a case where a plurality of radio communication terminals are connected to the AP, the AP can accurately estimate the position of the AP by using the position information and the information of the radio field intensity from each of the radio communication terminals. Further, this AP transmits the estimated position information of this AP to the router 13A.

The router 13A receives the position information from this AP and acquires the position information of the router 13A based on the received position information. The router 13A transmits the position information of the router 13A to the router 1 in response to a request from the router 1.

### MODIFIED EXAMPLE 2

A wireless WAN dongle (an USB module for connecting to the wireless WAN) is attached to the AP or the router. By doing so, the wireless WAN dongle is connected to a base station via a wireless communication line such as the 4G, 3G or LTE. The base station has own position information. In this case, the wireless WAN dongle acquires the position information of the base station via the wireless communication line and transmits this position information to the AP. Then, the AP transmits this position information to the router 13A. The router 13A regards the position information of the base station thus acquired as the own position information. The router 13A transmits the position information of the router 13A to the router 1 in response to a request from the router 1.

Alternatively, in a case where the wireless WAN dongle is attached to the AP or the router, the wireless WAN dongle may detect a radio field intensity received by the wireless WAN dongle in addition to the position information of the base station, and may supply information of the radio field intensity together with the position information of the base station to the AP. In this case, the AP estimates the position of this AP based on the position information of the base station and the information of the radio field intensity, and transits the position of this AP thus estimated to the router 13A. The router 13A transmits the position information of the router 13A to the router 1 in response to the request from the router 1.

Further, the wireless WAN dongle can estimate the position information of the router 13A by performing communication with a plurality of the base stations. In this case, the wireless WAN dongle acquires radio field from each of the plurality of the base stations and detects the position information of the respective base stations.

As the major position estimation method using radio wave, there are a cell ID method of regarding a cell range of the base station as the current position, a radio field intensity method of utilizing a received radio field intensity at the base station or the radio communication terminal, and a radio-wave arrival time difference method of receiving radio wave from the radio communication terminal by a plurality of the base stations and estimating the position utilizing the arrival time difference.

In an example using the radio-wave arrival time difference method among these methods, the wireless WAN dongle detects times required for acquiring radio wave from the respective base stations, and supplies information relating to the times required for acquiring the radio wave together with detected position information to the AP. The AP can estimate about how long the wireless WAN dongle is away from each of the base stations based on the times required for acquiring the radio wave. Thus, the AP accurately estimates a position of the AP (wireless WAN dongle) based on respective position information corresponding to the times required for acquiring the radio wave as to the plurality of base stations. Further, the AP transmits the position information of this AP thus estimated to the router 13A. The router 13A transmits the position information of the router 13A to the router 1 in response to the request from the router 1.

Incidentally, the present invention can be used for various kinds of applied examples described below.

### APPLIED EXAMPLE 1

An applied example 1 relates to an optimum route calculation in a case of performing communication between remote routers. In the case of performing communication between the remote routers, data is transferred via many routers. In this case, it is preferable to calculate an optimum route in order to minimize a delay caused during the data transfer. In such the calculation of the optimum route, the more the number of routes between these routers is, the more the calculation cost is required. However, according to the present invention, as the positions of the respective routers are known, the cost required for the route calculation can be reduced by, for example, limiting routes to one in which routers are positionally closed to each other.

### APPLIED EXAMPLE 2

In an applied example 2, as to the position of each of the routers, information such as a name and the number of stories of a building installed thereat is estimated as well as a latitude and a longitude thereof. The information such as the names and the floor numbers of the buildings is manually inputted by respective uses in advance as additional information of the position information of the respective APs and stored in the database 50. Each of the routers reads also the additional information as the position information of the AP from the database 50 and outputs the information such as the name and the number of stories of the building at which the own device is installed.

### APPLIED EXAMPLE 3

In an applied example 3, in place of the router, a position of another network device (such as a network camera or a network printer) connected to this router is estimated. Each of the routers acquires identification information (for example, an MAC address) of the network device connected to the own device in response to a request from the other device such as the center router or the PC and transmits both the identification information and position information in an association manner. By doing so, the other device such as the center router or the PC can know the positions of various kinds of the network devices.

### APPLIED EXAMPLE 4

Both the position information of the wired communication device and the position information of the network devices connected under the control of the wired communication device acquired according to the present invention can be used as position information of network devices in a system where network configuration is managed by a software. In particular, in a virtualizing technique for a network called an SDN (Software-Defined Network) having been notified in recent years, configuration and functions of the network is dynamically managed by a software operation. Thus, it is considered that a software algorithm or a network manager uses the position information acquired according to the present invention as one of determination criteria for determining a network route or as a means for determining a function of a management software. By doing so, the network manager can easily construct an optimum network considering the position information acquired according to the present invention.

### APPLIED EXAMPLE 5

Also in a management service for, for example, visualizing the network configuration, the position information acquired according to the present invention is displayed as visual position information on a GUI (Graphic User Interface) of the management service. By doing so, the position information can be dynamically updated and geographic positions of the network devices can be displayed in real time.

This application is based on Japanese Patent Application No. 2014-030231 filed on Feb. 20, 2014, the contents of which are incorporated herein by reference.

### REFERENCE SIGNS LIST

1: router

10A, 10B, 10C, 11A, 11B, 11C, 12A, 12B, 12C: AP

13A, 13B, 13C: router

20: terminal

20A, 20B, 20C: radio communication terminal

50: database

101: center base

102A, 102B, 102C: base

200: internet

1. A communication system comprising:
a radio relay device; and
a wired communication device connected to the radio relay device via a wire, wherein the wired communication device includes a processor and a memory storing instructions, the processor executing the stored instructions to:
perform wired communication with the radio relay device;
acquire identification information of the radio relay device via the wired communication;
acquire position information of the radio relay device based on the acquired identification information; and
output own position information based on the acquired position information.

2. The communication system according to claim 1, wherein
the processor of the wired communication device further executes the stored instructions to refer to a position information table to specify the position information of the radio relay device from the acquired identification information.

3. The communication system according to claim 2, wherein
the identification information is associated with the position information in the position information table.

4. The communication system according to claim 3, further comprising:
a radio communication terminal, wherein
the radio communication terminal includes a processor and a memory storing instructions, the processor executing the stored instructions to:
perform radio communication with the radio relay device;
acquire identification information of the radio relay device via the radio communication;
estimate a position of the radio relay device; and
output the position information table in which the estimated position is associated with the acquired identification information.

5. The communication system according to claim 4, wherein
the radio relay device includes a processor and a memory storing instructions, the processor executing the stored instructions to output a beacon signal containing the identification information, wherein
the processor of the radio communication terminal further executes the stored instructions to:
specify a position of the radio communication terminal; and
measure a received radio field intensity of the beacon signal, and wherein
the processor of the radio communication terminal executes the stored instructions to estimate the position of the radio relay device based on the specified position of the radio communication terminal and the received radio field intensity of the beacon signal.

6. The communication system according to claim 3, further comprising:
a radio communication terminal, wherein
the radio relay device includes a processor and a memory storing instructions, the processor executing the stored instructions to output a beacon signal containing the identification information, wherein
the processor of the radio communication terminal further executes the stored instructions to:
perform radio communication with the radio relay device;
specify a position of the radio communication terminal; and
measure a received radio field intensity of the beacon signal, wherein
the processor of the radio communication unit executes the stored instructions to transmit the specified position of the radio communication terminal and the received radio field intensity of the beacon signal to the radio relay device, and wherein
the radio relay device includes a processor and a memory storing instructions, the processor executing the stored instructions to:
estimate a position of the radio relay device based on the position of the radio communication terminal and the received radio field intensity of the beacon signal received from the radio communication terminal; and
output the position information table in which the estimated position of the radio relay device is associated with identification information of the radio relay device.

7. The communication system according to claim 2, further comprising:
a database which stores the position information table, wherein
the processor of the wired communication device executes the stored instructions to read the position information of the radio relay device from the database.

8. The communication system according to claim 1, comprising:
a center device which is connected to a plurality of wired communication devices, wherein
the center device includes a processor and a memory storing instructions, the processor executing the stored instructions to:
transmit a position information request to each of the wired communication devices, wherein
the processor of the wired communication device further executes the stored instructions to output the own position information to the center device in a case where the position information request is received, and wherein
the processor of the center device further executes the stored instructions to receive the position information corresponding to the position information request.

9. The communication system according to claim 2, wherein
the processor of the wired communication device executes the stored instructions to cause the radio relay device to refer to the position information table, thereby acquiring the position information of the radio relay device.

10. A wired communication device, comprising:
a processor; and
a memory storing instructions the processor executing the stored instructions to:
perform wired communication with a radio relay device;
acquire identification information of the radio relay device via the wired communication;
acquire position information of the radio relay device based on the acquired identification information; and
output own position information based on the acquired position information.

11. The wired communication device according to claim 10, wherein
the processor executes the stored instructions to refer to a position information table in a database to specify the position information of the radio relay device.

12. The wired communication device according to claim 11, wherein
the database associates the identification information with the position information in the position information table.

13. The wired communication device according to claim 10, wherein
the processor executes the stored instructions to output the own position information that indicates the acquired position information as it is.

14. The wired communication device according to claim 10, wherein
the processor executes the stored instructions to output the own position information in which a plurality of acquired position information is averaged.

15. The wired communication device according to claim 11, wherein
the processor executes the stored instructions to cause the radio relay device refer to the position information table, thereby acquiring the position information of the radio relay device.

16. A control method in a wired communication device which performs wired communication with a radio relay device, the control method comprising:
acquiring identification information of the radio relay device via a wired communication unit;
acquiring position information of the radio relay device based on the acquired identification information; and
outputting position information of the wired communication device based on the acquired position information.

17. The control method according to claim 16, wherein
the position information of the radio relay device is specified by referring to a position information table in a database.

18. The control method according to claim 17, wherein
the database associates the identification information with the position information in the position information table.

19. (canceled)

20. The control method according to claim 16, wherein
the position information of the wired communication device, in which a plurality of position information thus acquired is averaged, is outputted.

21. The control method according to claim 17, wherein
the position information of the radio relay device is acquired by causing the radio relay device to refer to the position information table.

22. (canceled)
